(19) United States
(12) Patent Application Publication
(10) Pub. No.: US 2025/0283720 A1
(43) Pub. Date: Sep. 11, 2025

(54) MINIATURIZED INTERFEROMETRIC INTEGRATED PHOTONIC GYROSCOPE

(71) Applicant: OSCPS MOTION SENSING INC., Montreal (CA)

(72) Inventors: Kazem ZANDI, Montreal (CA); Ramanand TEWARI, Ottawa (CA); Laurie Richard WILLISTON, London (CA)

(21) Appl. No.: 18/862,592

(22) PCT Filed: Jun. 14, 2023
(86) PCT No.: PCT/CA2023/050826

§ 371 Date: Nov. 4, 2024

Related U.S. Application Data
(60) Provisional application No. 63/351,894, filed on Jun. 14, 2022.

(51) Int. Cl. G01C 19/72

(52) U.S. Cl. CPC G01C 19/721

(57) ABSTRACT

A miniaturized interferometric integrated photonic gyroscope structure with top silicon oxide, middle silicon oxide and bottom silicon oxide deposited on a silicon substrate comprises broadband optical source or a semiconductor optical amplifier with silicon nitride ring resonator wavelength filter, connected with a thin film lithium niobate or piezoelectrically actuated silicon nitride phase modulator vertically coupled with a silicon nitride waveguide spiral loop. The silicon nitride waveguide spiral loop is patterned on thin bottom oxide layer with air trenches below it and connected with a germanium detector either through photonic wire bonding or vertically integrated through reflecting mirror embedded into silicon wafer. Various methods of coupling alternative materials are described and the potential of connecting several spiral waveguides for enhanced sensitivity in a gyroscope application.

### CROSS-REFERENCE

The present application claims priority to U.S. Provisional Patent Application No. 63/351,894, filed 14 Jun. 2022, the entirety of which is incorporated by reference herein.

### TECHNICAL FIELD

The present technology generally relates to miniaturized interferometric integrated photonic gyroscopes.

### BACKGROUND

As remote controlled and autonomous vehicles (such as drones) become more common, there is increasing interest in gyroscopes as sensors for measuring angular velocity. One type of gyroscope in the field of measuring angular velocity is an integrated photonic gyroscope, where the effect of rotation on light signals are monitored to detect rotational speed of an apparatus. In such devices, a light phase shift due to the Sagnac effect is used to measure angular velocity. With no moving parts, there are intrinsic advantages of reliability expected from such devices over competing technologies.

Optical gyroscopes, for instance optical ring resonator-based optical (fiber optic) gyroscopes, use optical elements, such as lasers, beam splitters, polarizers, phase modulators, circulators, resonators, and photodetectors. In order to provide accurate measurements, the various optical elements need to be precisely and stably aligned. In some cases, this can require bulky mechanical supports in order to precisely and reliably align the different optical elements.

Optical gyroscopes also require electrical or electronic elements, such as wave generators, lock-in amplifiers, FPGA, and computer-implemented devices. These elements can be bulky, and the size of the different optical and electrical elements limit how small a gyroscope can be made. For many applications such as drones, however, smaller gyroscopes could be preferable (or necessary). All of the components, both optical and electrical/electronic, further require electrical connections to be made between the components.

There remains a desire for advancements in inertial measurement systems.

### SUMMARY

It is an object of the present technology to ameliorate at least some of the inconveniences present in the prior art or to provide methods of enhanced device performance.

It should be understood that at least some of the elements described herein could be fabricated by deposition. Chemical vapour or physical deposition techniques, as well as other deposition techniques such as layer bonding, as described herein, of various layers on the substrate and other layers provides immovable attachment of the layers to the substrate and the other layers, respectively.

The term “deposit” in reference to fabrications methods, as used herein, refers broadly to methods and processes of mechanically and/or chemically applying a material to one or more desired locations, or as a layer, on a surface, as well as patterning or removal of select areas of deposited films. The methods and processes encompassed by the term “deposit” herein include but are not limited to: spin-coating, photo-resist development and etching, photolithography, electron-beam lithography, thermal oxidation, plasma etching, wet etching, electron beam deposition, low pressure chemical vapor deposition, plasma enhanced chemical vapor deposition, and physical vapor deposition.

Quantities or values recited herein are meant to refer to the actual given value. The term “about” is used herein to refer to the approximation to such given value that would reasonably be inferred based on the ordinary skill in the art, including equivalents and approximations due to the experimental and/or measurement conditions for such given value.

According to non-limiting embodiments of the present technology, there is provided an integrated photonic gyroscope comprising: a light source; a wavelength filter optically connected to the light source; at least one interferometric spiral loop optically connected to a wavelength filter, the interferometric spiral loop being formed from silicon nitride; and a detector optically connected to the interferometric spiral loop for receiving light therefrom.

In some embodiments, the wavelength filter comprises at least one ring resonator filter formed from silicon nitride.

In some embodiments, the integrated photonic gyroscope further includes a phase modulator optically connected between the at least one interferometric spiral loop and the detector.

In some embodiments, the integrated photonic gyroscope further includes a phase modulator optically connected between the wavelength filter and the at least one interferometric spiral loop.

In some embodiments, the integrated photonic gyroscope further includes a substrate; and the at least one wavelength filter is formed in a first material layer disposed on the substrate, and the phase modulator is formed in a second material layer disposed parallel to the first layer.

In some embodiments, the integrated photonic gyroscope further includes a substrate; and the at least one wavelength filter and the phase modulator are formed in a material layer connected to the substrate.

In some embodiments, the phase modulator is at least one thin film lithium niobate waveguide (TFLN) phase modulator; and the at least one TFLN phase modulator includes: at least one lithium niobate waveguide, and a plurality of metal electrodes disposed adjacent to the at least one lithium niobate waveguide.

In some embodiments, the phase modulator is at least one SiN/PZT phase modulator; and the at least one SiN/PZT phase modulator includes: a silicon nitride waveguide, and electrodes including lead zirconate titanate (PZT), the electrodes being horizontally displaced from the waveguide.

In some embodiments, the integrated photonic gyroscope further includes at least one photonic wire bond connecting a waveguide to the detector.

In some embodiments, the integrated photonic gyroscope further includes a waveguide formed from thin film lithium niobate (TFLN), and a Germanium detector formed on silicon substrate.

In some embodiments, the integrated photonic gyroscope further includes a plurality of horizontally straight and tapered evanescent field vertical couplers and evanescent coupling occurs between vertically placed dissimilar silicon nitride and silicon waveguides.

In some embodiments, the integrated photonic gyroscope further includes a vertical coupling region comprising: a silicon nitride straight waveguide after tapering having an about 0.5 um width and an about 100 nm thickness; a silicon waveguide having an about 500 nm width and about 220 nm thickness; and a vertical separation between silicon nitride straight waveguide and a silicon waveguide of: about 1.95 um for 10% coupling, 0.88 um for 50% coupling, and 0.18 um for 97% coupling.

In some embodiments, the integrated photonic gyroscope further includes a plurality of horizontally straight and tapered evanescent field vertical couplers; and evanescent coupling occurs between vertically placed dissimilar silicon nitride and lithium niobate waveguides.

In some embodiments, the integrated photonic gyroscope further includes a vertical coupling region comprising: a silicon nitride straight waveguide having an about 2.8 um width and an about 100 nm thickness; a lithium niobate waveguide having an about 1.5 um width and an about 100 nm thickness; and a vertical separation between silicon nitride straight waveguide and the lithium niobate waveguide by about 0.825 um for 99.97% coupling.

In some embodiments, the integrated photonic gyroscope further includes a reflecting mirror formed from silicon, the reflecting mirror providing optical coupling between the at least one interferometric spiral loop and the at least one detector.

In some embodiments, the integrated photonic gyroscope further includes at least one vertical coupler; and a plurality of etched cavities defined in material below the at least one interferometric spiral loop, none of the plurality of etched cavities being defined in regions immediately below a coupling region defined around the at least one vertical coupler.

In some embodiments, the light source comprises at least one of: a distributed feed back (DFB) laser; a super luminescent diode (SLD) source; and an amplified spontaneous emission (ASE) source.

In some embodiments, the light source comprises a semiconductor optical amplifier (SOA).

According to some non-limiting examples of the present technology, there is provided an integrated photonic gyroscope comprising: a semiconductor optical amplifier (SOA); at least one interferometric spiral loop optically connected to a wavelength filter, the at least one interferometric spiral loop being formed from silicon nitride; and a detector optically connected to the interferometric spiral loop for receiving light therefrom.

Embodiments of the present disclosure each have at least one of the above-mentioned objects and/or aspects, but do not necessarily have all of them. It should be understood that some aspects of the present disclosure that have resulted from attempting to attain the above-mentioned object may not satisfy this object and/or may satisfy other objects not specifically recited herein.

Additional and/or alternative features, aspects and advantages of embodiments of the present disclosure will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective, schematic view of a non-limiting embodiment of a miniaturized interferometric integrated photonic gyroscope, where the phase modulator is disposed between the spiral loop and the detector, and the beam propagates either in clockwise or counterclockwise direction;

FIG. 2 is the cross-sectional view of miniaturized interferometric fiber optic gyroscope of FIG. 1;

FIG. 3 is a perspective schematic view of another non-limiting embodiment of a miniaturized interferometric integrated photonic gyroscope, where the thin film lithium niobate (TFLN) phase modulator is placed between the light source and the spiral loop, with a light beam thereof propagating either in a clockwise or counterclockwise direction during use;

FIG. 4 is a cross-sectional view of the miniaturized interferometric integrated photonic gyroscope of FIG. 3;

FIG. 4(a) is a perspective schematic view of another non-limiting embodiment of a miniaturized interferometric integrated photonic gyroscope, with the beams propagating in clockwise as well as in counterclockwise direction during use;

FIG. 5 is a perspective schematic view of another non-limiting embodiment of a miniaturized interferometric integrated photonic gyroscope having an evanescent field vertical coupler;

FIG. 6 is a simulation of coupling between two vertical couplers of FIG. 5;

FIG. 7 is a simulation of coupling between two vertical couplers of FIG. 3;

FIG. 8 is a perspective, schematic view of 4 spiral loops connected through silicon nitride tapered waveguide evanescent field vertical couplers;

FIG. 9 is a perspective schematic view of evanescent field vertical couplers where the evanescent coupling takes place between the two vertically placed silicon nitride waveguides;

FIG. 10 is a simulation of coupling between the two vertical couplers of FIG. 9;

FIG. 11 is a simulation of minimum rotation versus spiral length that include the shot noise and thermal noise along with the total noise that is the sum of the shot noise and thermal noise for the silicon nitride waveguide propagation loss 0.5 dB/meter;

FIG. 12 is a simulation of minimum rotation versus spiral length that include the shot noise and thermal noise along with the total noise that is the sum of the shot noise and thermal noise for a silicon nitride waveguide propagation loss 3 dB/meter;

FIG. 13 is a perspective schematic view of a spiral loop with waveguide crossings, such that all waveguide crossings are perpendicular to reduce crosstalk;

FIG. 14 is a simulation of power remained in the output waveguide of the spiral of FIG. 13 after propagating the seven waveguide crossings, from the point A to B;

FIG. 15 is a perspective schematic view of a spiral loop where silicon underneath the waveguides within region (area) enclosed between the broken lines will be etched;

FIG. 16 is a perspective schematic view of a spiral loop where at the central of spiral loop a reflecting mirror is constructed that reflects the beam in vertical direction to the detector;

FIG. 17 is a cross-sectional view of the structure of FIG. 16; and

FIG. 18 is the perspective cross sectional view of PZT phase modulator with U-shaped PZT material.

It is to be understood that throughout the appended drawings and corresponding descriptions, like features are identified by like reference characters. Furthermore, it is also to be understood that the drawings and ensuing descriptions are intended for illustrative purposes only and that such disclosures do not provide a limitation on the scope of the claims. It should be noted that the Figures may not be drawn to scale, except where otherwise noted.

### DETAILED DESCRIPTION

The present disclosure is directed to systems, methods and apparatuses to address the deficiencies of the current state of the art.

The phase difference in gyroscopes of the type described herein is determined using the Sagnac Effect. The phase difference between the two counterpropagating waves, is cumulated over a long optical waveguide coil (also referred to as loops) in order to obtain high responsivity with a compact device. For ideal integrated optic waveguides and components, the output photogenerated current I can be described by the expressions:

$${I}_{1} = {I}_{01} ( 1 - cos {φ}_{S} ) , \qquad Eq . ( 1 )$$

$${I}_{2} = {I}_{02} ( 1 + cos {φ}_{S} ) , and \qquad Eq . ( 2 )$$

$${I}_{0} = σ P / 2 , \qquad Eq . ( 3 )$$

where φ_{S} is the so-called Sagnac phase shift, σ is the photodetector responsivity and P is the power coupled into the input integrated optic waveguide.

The Sagnac phase shift φ_{S} is the phase shift difference between two counterpropagating waves along the same optical path, and is described by the expression:

$${φ}_{S} = Ω * ( 2 π NLD / λ c ) , \qquad Eq . ( 4 )$$

where Ω is the angular velocity, λ is the vacuum wavelength, N is the number of loops of the integrated optic waveguide coil, D is the diameter of integrated optic waveguide coil and L is the length of the integrated optic waveguide coil.

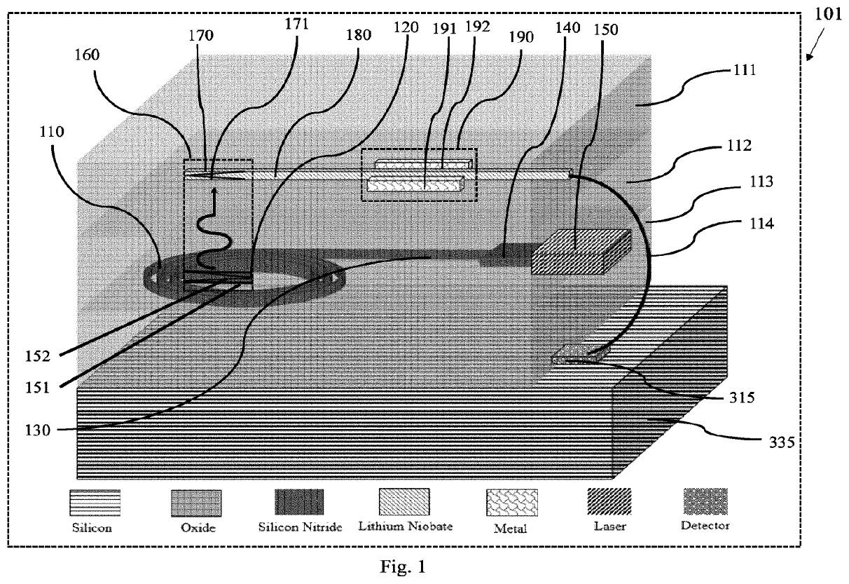

FIG. 1 is the perspective schematic view of an interferometric integrated photonic gyroscope 101. The gyroscope 101 includes an interferometric sensing element or spiral, a phase modulator, a photodiode, a light source or laser diode, isolating support elements such as silicon oxide layers, all on a support wafer or substrate. The phase modulator is shown with actuator electrodes for electrical regulation of phase and can be fabricated from lithium niobate with metal electrodes or silicon nitride with a piezoelectric electrode. The spiral is composed of a silicon nitride waveguide which when surrounded by silicon oxide acts to constrain the optical modes travelling in the waveguide.

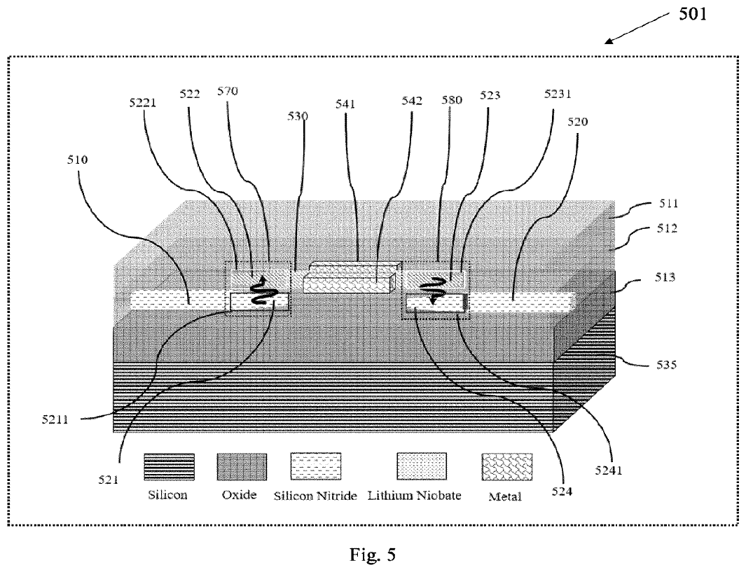

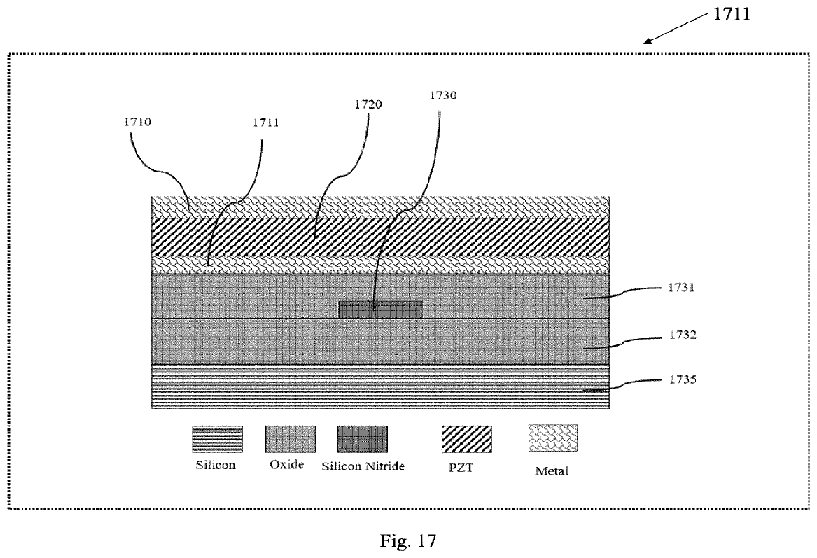

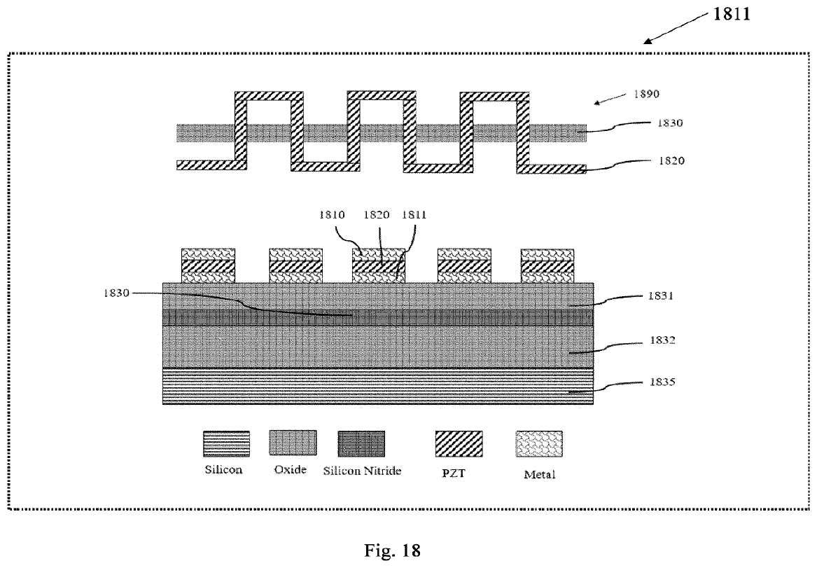

In this embodiment, the phase modulator 190 is placed between the spiral loop 110 and the detector 315. The phase modulator 190 can be a thin film lithium niobate (TFLN) phase modulator as shown in FIG. 5 or a lead zirconate titanate (PZT) phase modulator as shown in FIGS. 17 and 18. See also, for instance, “Ultra-low power stress-based phase actuation in TriPlex photonic circuits”, Everhardt et al., Proc. SPIE 12004, Integrated Optics: Devices, Materials, and Technologies XXVI, 1200405 (5 Mar. 2022), referred to herein as “Everhardt”, the entirety of which is incorporated by reference herein.

The light from a broadband laser or semiconductor optical amplifier (SOA) 150 is launched into the input waveguide 130 of the spiral loop 110. In case if the light source 150 is an SOA then it is externally coupled to a wavelength filter 140. In case of broadband laser there is no need of a wavelength filter 140. The wavelength filter 140 is made of silicon nitride ring resonators with Vernier effect is placed after the SOA 150 to further narrow down the linewidth of the SOA 150. The light travels into the silicon nitride spiral loop input waveguide 130 to the spiral loop 110 that forms the sensing element of gyro for measuring the Sagnac effect. In the coupling region 160, the output light from the center of the spiral loop 120 is vertically coupled to the input straight waveguide 170 or the input tapered waveguide 171 of the thin film lithium niobate waveguide 180 placed between the two metal electrodes 191 and 192 that constitutes the thin film lithium niobate (TFLN) phase modulator 190. Similarly, the SiN phase modulator can be used actuated by the horizontally coupled PZT. In the coupling region 160 the coupled waveguides can be the straight waveguide 170 or the straight waveguide 151 or tapered waveguide 171 or tapered waveguide 152 as shown in the FIG. 1 and in more details as shown in FIG. 5. The silicon/germanium detector 315 is attached to the silicon substrate 335. The output light from the phase modulator is coupled into the silicon/germanium detector 315 through photonic wire bonding 114 which are fabricated using direct-write 3D laser lithography based on two-photon polymerization. First the detector 315 is fixed on the silicon substrate 335 and then the interconnect region between the lithium niobate waveguide 180 and the detector 315 is embedded into a photosensitive polymer. The shape of the photonic wire bond waveguide is then designed using two-photon lithography. The layers 111, 112 and 113 forms the top, buffer and bottom layers of the waveguide 101 which are formed on the silicon substrate 335. The silicon nitride ring 110 is patterned on the bottom oxide layer 113.

In some embodiments, the light source 150 could be replaced by a SLD or ASE broadband source to minimize the backscattering noise in the spiral loop 110. The SLD or ASE broadband source can have operating wavelength of about 1310 nm or 1550 nm.

In another embodiment, the positions of laser and SOA along with the wavelength filter can be interchanged with the position of detector.

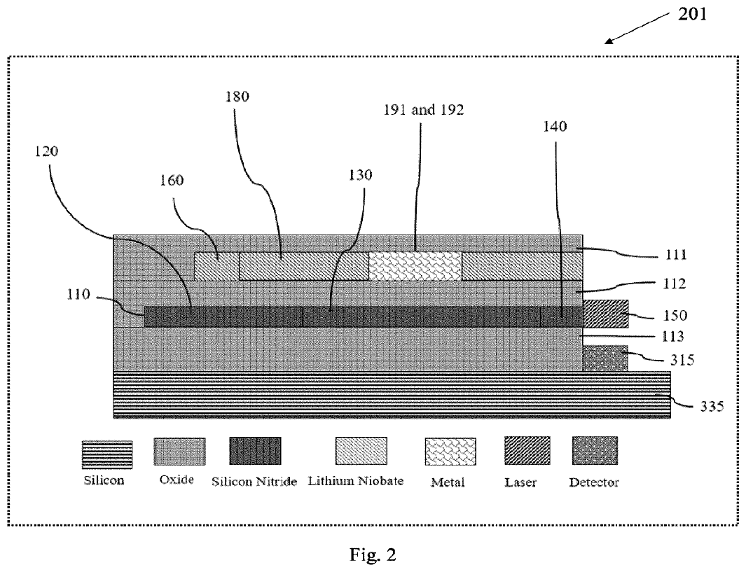

FIG. 2 is the cross-sectional view of miniaturized interferometric integrated photonic gyroscopes of FIG. 1, providing additional illustration of the phase modulator 190 being disposed between the spiral loop 110 and the detector 315.

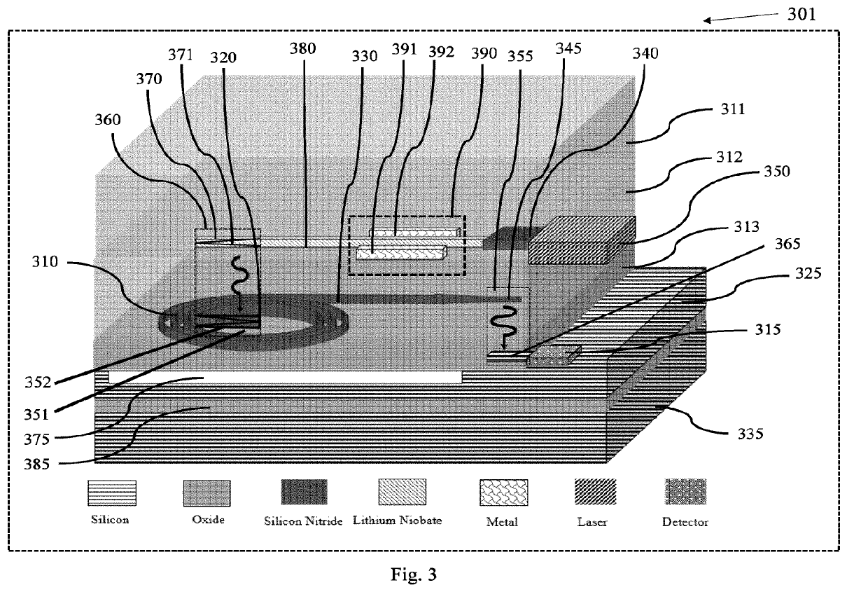

FIG. 3 is a perspective schematic view 301 of a miniaturized interferometric integrated photonic gyroscope where the phase modulator 390 is placed between the light source (laser or SOA) 350 and the spiral loop 310. The phase modulator 390 can be a thin film lithium niobate (TFLN) phase modulator as shown in FIG. 5 or a SiN/PZT phase modulator as shown in FIGS. 17 and 18 and also in Everhardt.

The light from the light source 350 is launched into the center 320 of the spiral loop 310 made with silicon nitride waveguide. In case if 350 is an SOA it is externally coupled to a wavelength filter 340. In case of a broadband laser there is a no need of the wavelength filter 340. The wavelength filter 340 is made of silicon nitride ring resonators using Vernier effect is placed after the SOA 350 to further narrow down the linewidth SOA 350. The output of the waveguide filter 340 made with silicon nitride is coupled to the lithium niobate waveguide 380 through spot converter not shown in the figure and placed between the two metal electrodes 391 and 392 that constitutes the thin film lithium niobate (TFLN) phase modulator 390. In the coupling region 360 the coupled waveguide can be the straight waveguide 370 or the straight waveguide 351 or the tapered waveguide 371 or tapered waveguide 352 as shown in FIG. 1 or in more details as shown in FIG. 5. The modulated light is coupled down to the central 320 of the spiral loops 310 that forms the sensing element of gyro for measuring the Sagnac effect, through straight waveguide 370 or through horizontally tapered vertical coupler 371 via the coupling region 360. The light from the output waveguide 330 of the spiral loop 310 is coupled into the silicon/germanium detector 315 in the coupling region 355. In the coupling region 355 the silicon nitride waveguide has been tapered down to a linear waveguide with width 1.5 um to match the effective index with the effective index of silicon waveguide 365. The silicon/germanium detector 315 is fabricated on, or attached to, silicon 325. In the illustrated embodiment, the silicon layer 325 supports the spiral loop 310 and the output of the spiral loop 330 has a plurality of air trenches 375 formed therein (also referred to as etched cavities). It is noted that the air gap 375 as illustrated in the Figures is simply representative of a region 375 in which many air trenches are formed. For additional information on formation and effects of air cavities, see also U.S. patent application Ser. No. 18/110,989, filed on Feb. 17, 2023, the entirety of which is incorporated by reference herein. Between the silicon nitride spiral loop 310 and the air cavities 375 there is thin oxide layer 313.

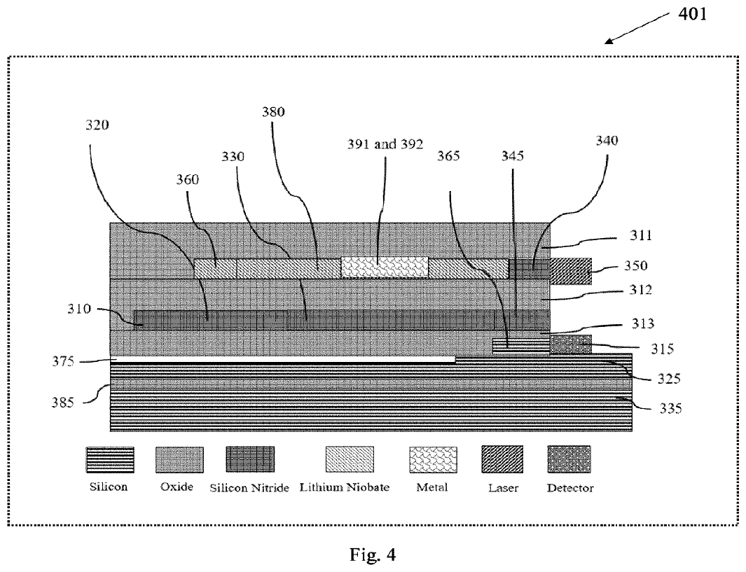

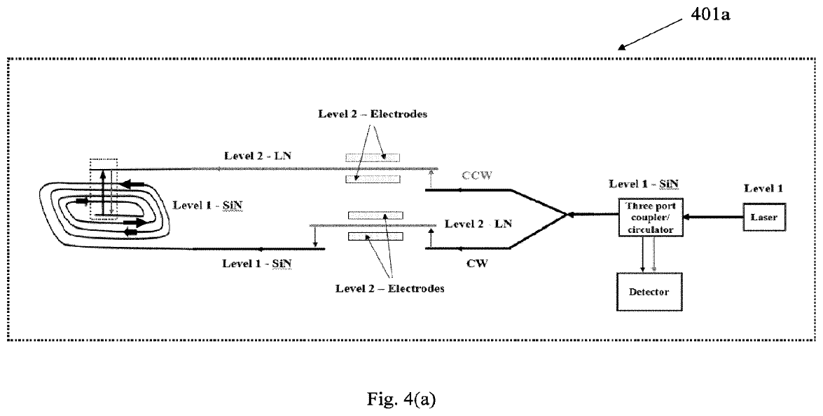

FIG. 4 is the cross-sectional view 401 of the miniaturized interferometric integrated photonic gyroscope of FIG. 3, where the phase modulator 390 is placed between the wavelength filter 340 and the spiral loop 310. In this FIG. 4, the labeling of the components and layers are kept the same as of FIG. 3.

FIG. 4(a) is a perspective schematic view 401a of miniaturized interferometric integrated photonic gyroscopes where the beams propagate in clockwise as well as in counterclockwise direction. In this figure a laser, a three-port coupler which also acts as a circulator, and a spiral loop are placed in a first material layer, while the two-phase modular each of the two consists of a thin film lithium niobate and two metal electrodes, disposed in a second material layer, parallel to the first material layer. The arrows in the figure illustrate the direction of vertical coupling from the silicon nitride to the thin film lithium niobate and vice versa. The clockwise and the counterclockwise beams are combined and three port coupler to form an interference beam. When there is no rotation then there will be no Sagnac phase shift while when there is rotation then Sagnac phase shift occurs.

FIG. 5 is the perspective schematic view of evanescent field vertical coupler 501 where the evanescent coupling takes place between the two vertically placed silicon nitride and the lithium niobate waveguides in the coupling region 570 or 580. The coupling region 570 can have coupled silicon nitride straight waveguide 5211 and lithium niobate straight waveguide 5221 or the tapered silicon nitride straight waveguides 521 and tapered lithium niobate waveguide 522. In the similar way, the coupling region 580 can have coupled silicon nitride straight waveguide 5231 and lithium niobate straight waveguide 5241 or the tapered lithium niobate straight waveguide 523 and tapered silicon nitride waveguide 524. Light from the lower silicon nitride waveguide 521 or 5211 is vertically coupled to the upper lithium niobate waveguide 522 or 5221 in the vertical coupling region 570 through vertical evanescent coupling. The power coupled to the waveguide 530 can be varied by changing the vertical gap between the waveguides 510 and 530 and also by changing the length of the overlap region between the waveguides 5211 and 5221 or 521 and 522. In a similar fashion, light can be coupled back to the lower silicon nitride waveguide 520 from the upper lithium niobate waveguide 530 in the vertical coupling region 580 through vertical evanescent coupling. The advantages of the silicon nitride and lithium niobate tapered waveguides in the coupling regions 570 and 580 are to provide efficient vertical coupling with much smaller coupling length. The input waveguide 510 and the output waveguide 520 are patterned on silicon oxide layer 513 while the lithium niobate waveguide 530 is patterned on silicon oxide layer 512. The surface-to-surface gap between the upper lithium niobate waveguide 530 and the lower silicon nitride input waveguide 510 and the lower silicon nitride output waveguide 520 can be varied to adjust the maximum vertical coupling efficiency. The light beam propagating in the thin film lithium niobate waveguide (TFLN) 530 is phase modulated through two electrodes 541 and 542 placed adjacent to the TFLN waveguide 530 and this phase modulated light beam is exited through the output waveguide 520. The layers 511, 512 and 513 forms the top, buffer and bottom layers of the waveguide 105 which are formed on the silicon substrate 535.

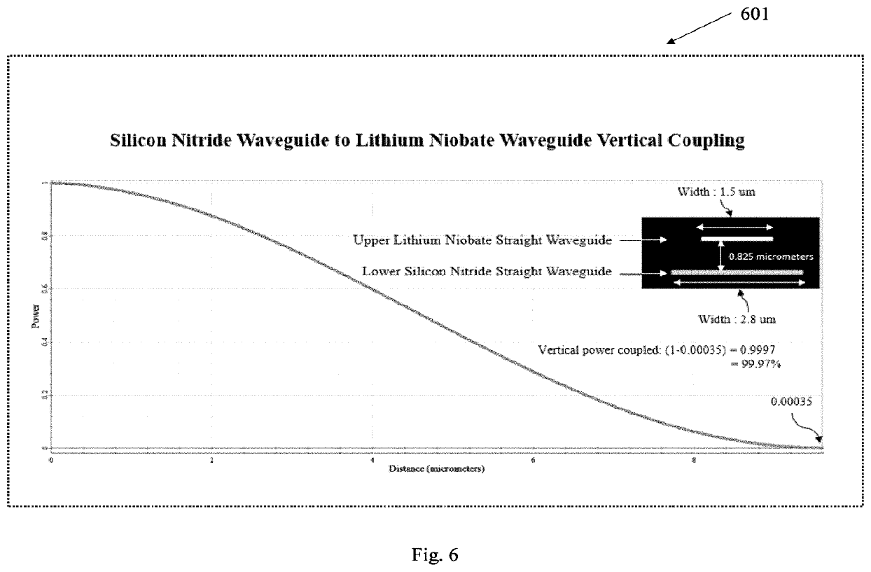

FIG. 6 shows the simulated results 601 for the vertical power coupled from the input lower silicon nitride straight waveguide 510 to the output upper lithium niobate straight waveguide 530 in the coupling region 570 of FIG. 5. As can be seen from this figure that for the silicon nitride waveguide width of 2.8 μm and thickness 100 nm and for the lithium niobate waveguide width of 1.5 μm and thickness of 100 nm, when the surface to surface gap between the two vertical waveguides is 0.825 μm and coupling length is 9.6 um, the output power remained in the input silicon nitride waveguide 510 is 0.00035 or power coupled to the output vertical lithium niobate waveguide 530 is 0.9997 or 99.97%. Similarly, the vertical power coupled from the upper lithium niobate waveguide 530 to the lower silicon nitride waveguide 520 in the coupling region 580 of FIG. 5 is 99.97%. For this simulation, the refractive index of the silicon nitride is chosen to be 2.08 and for lithium niobate it is chosen to be 2.2.

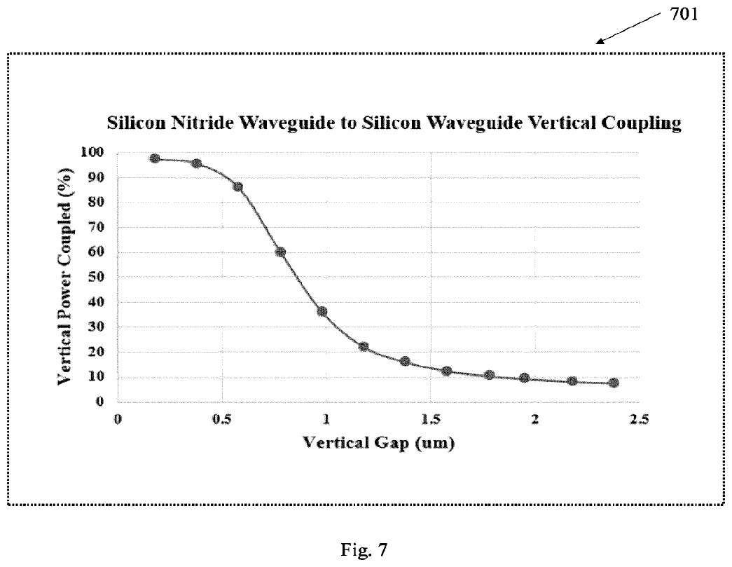

FIG. 7 shows the simulated results 701 of the vertical power coupled from silicon nitride waveguide 345 to the silicon waveguide 365 that is attached to the detector 315 as shown in the FIG. 3. The vertical coupling takes place in coupling region 355 as shown in the FIG. 3. Referring to FIG. 7, when the vertical gap between the upper surface of the silicon waveguide 365 and lower surface of the silicon nitride waveguide 345 of FIG. 3 is 0.18 um then about 97% light gets coupled to the silicon waveguide 365 in FIG. 3. On the other hand, when the vertical gap between the upper surface of the silicon waveguide 365 and lower surface of the silicon nitride waveguide 345 increases to 2.38 um then the coupled light goes down to 7.7%. However, for a typical vertical gap of 1.95 um about 9.3% of light gets coupled to the silicon waveguide 365 from the silicon nitride waveguide 345. The simulations have been done for the tapered single mode silicon nitride waveguide 345 of width 0.5 μm and thickness 100 nm and for a fab recommended standard single mode silicon waveguide 365 of width 0.5 μm and thickness 0.22 um.

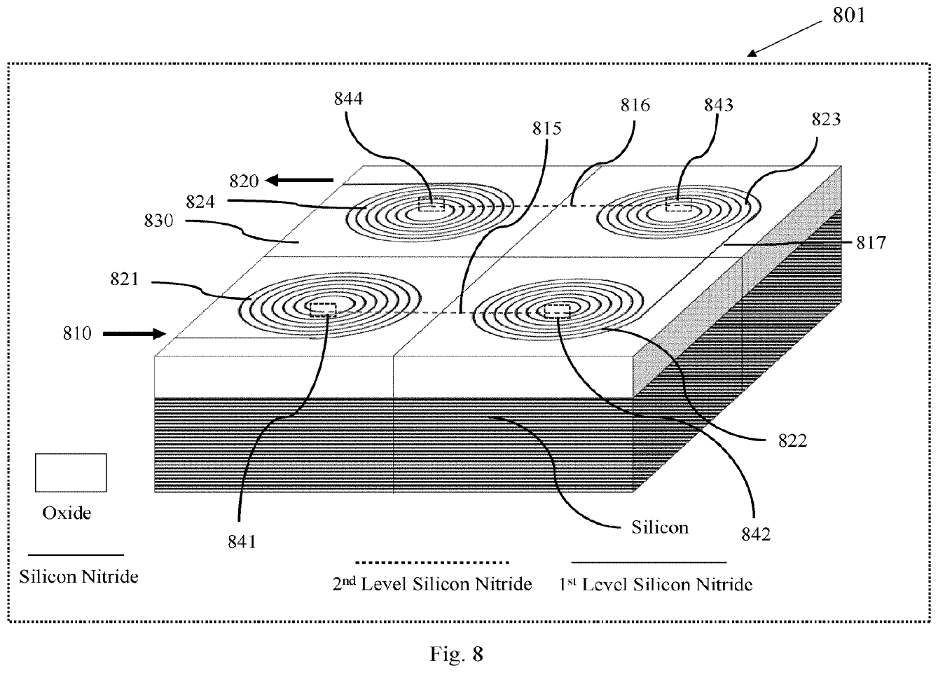

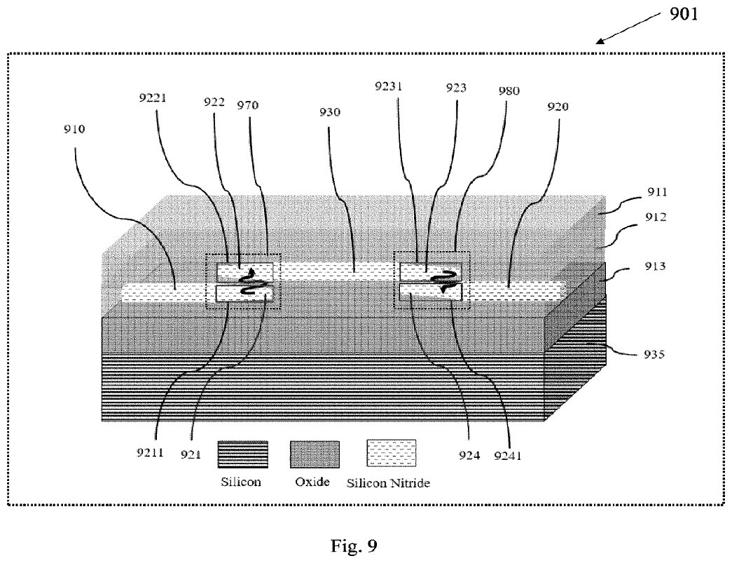

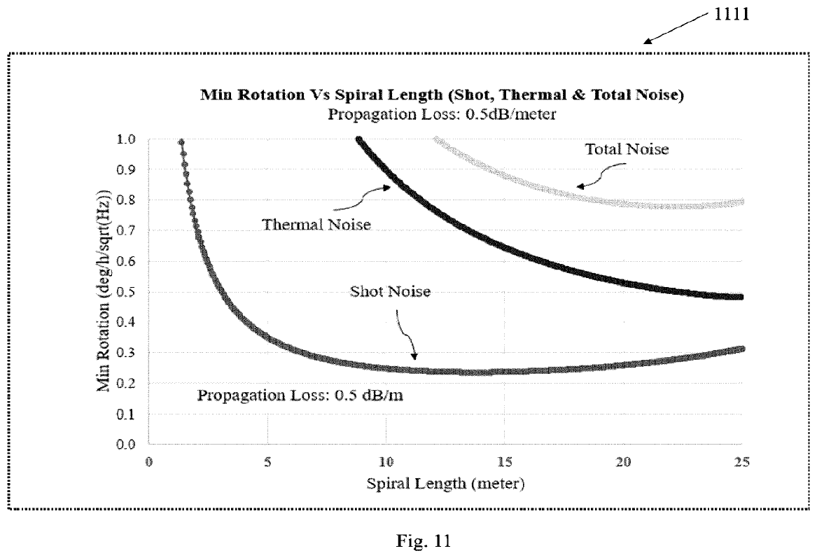

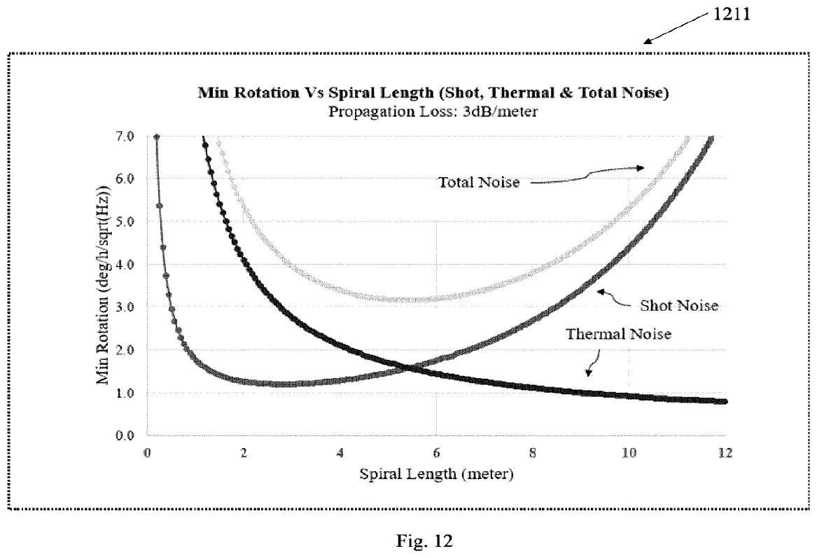

FIG. 8 is the perspective schematic view 801 of 4 spiral loops on separate dies connected through the two-silicon nitride waveguide evanescent field vertical couplers as shown by dashed lines 815 and 816 and also shown schematically in FIG. 9. In some embodiments, these 4 spiral loops could be implemented in place of the single spiral loop illustrated in FIGS. 1 and 3. The increased loop length beyond what is achievable on one die for increased sensitivity. Referring to FIG. 8, the 4 spiral loops are formed of the single spiral loops of FIGS. 1 and 3 but represent a method for connecting four adjacent dies for increased loop area and enhanced sensitivity. FIG. 12 shows that for high loss waveguides with 3 dB per meter loss, there is no benefit for increase silicon nitride waveguide length, but for low loss silicon nitride waveguides of FIG. 11 shows that some benefit exists.

Referring to FIG. 8, a method of increasing gyroscope sensitivity is indicated for increasing the maximum spiral length attainable on the area of one die, by bridging several dies together when waveguide loss is low enough. The spirals all have to coil in the same direction to enhance the Sagnac affect. The input silicon nitride waveguide 810, the output silicon nitride waveguide 820 and the loop 1 (821), loop 2 (822), loop 3 (823) and loop 4 (824) are 1^{st} level silicon nitride as shown by continuous lines and patterned on silicon oxide 830 while the vertical couplers 815 and 816 are 2^{nd} level silicon nitride as shown by dashed lines and patterned on the middle layer silicon oxide thickness of 1.95 um. The bridging nitride layers cross dicing lines and can be formed by lithographic processes in one step, or by stitching or offset lithography where necessary.

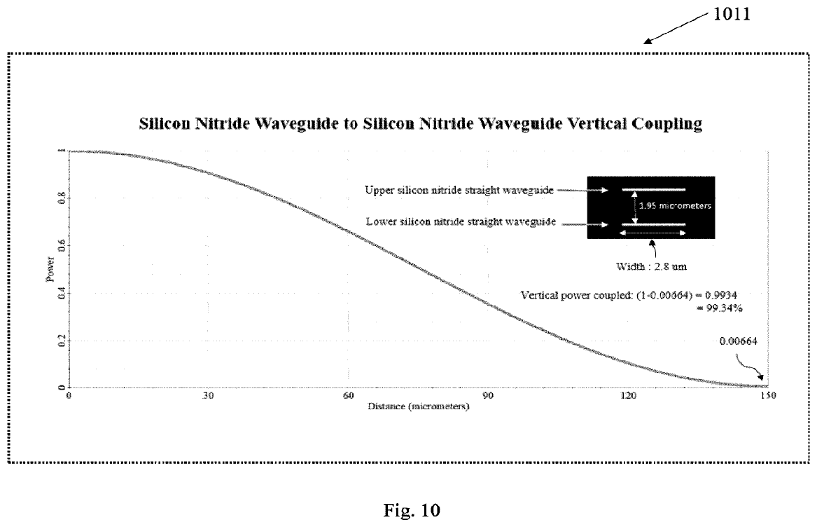

Referring to FIG. 8, the light from the laser 810 is launched into the loop 1 (821) and is vertically up-coupled to the silicon nitride vertical coupler 815 via coupling region 841 and then vertically down-coupled to loop 2 (822) via coupling region 842. The light from the loop 2 (822) propagates to the loop 3 (823) through connecting waveguide (817). From loop 3 (823) light gets vertically coupled to the loop 4 (824) via coupling region 843 to the vertical coupler 816 and then vertically coupled down to the loop 4 (824) via coupling region 844 and exiting through the output waveguide 820. The amount of light coupled in the coupling regions 841, 842, 843 and the 844 is illustrated in FIG. 10 and described in para 46.

FIG. 9 is the perspective schematic view of evanescent field vertical coupler 901 where the evanescent coupling takes place between the two vertically placed silicon nitride waveguides in the coupling region 970 or 980. The coupling region 970 can have coupled silicon nitride straight waveguides 9211 and 9221 or the tapered silicon nitride straight waveguides 921 and 922. In the similar way, the coupling region 980 can have coupled silicon nitride straight waveguides 9231 and 9241 or the tapered silicon nitride straight waveguides 923 and 924. Light from the lower input silicon nitride waveguide 921 or 9211 is vertically coupled to the upper silicon nitride waveguide 922 or 9221 in the vertical coupling region 970 through vertical evanescent coupling. The power coupled to the waveguide 930 can be varied by changing the vertical gap between the waveguides 910 and 930 and also by changing the length of the overlap region between the waveguides 9211 and 9221 or 921 and 922. In a similar fashion, light can be coupled back to the lower silicon nitride waveguide 920 from the upper silicon nitride waveguide 930 in the vertical coupling region 980 through vertical evanescent coupling. The advantages of the silicon nitride tapered waveguides in the coupling regions 970 and 980 are to provide efficient vertical coupling with much smaller coupling length. The input waveguide 910 and the output waveguide 920 are patterned on silicon oxide layer 913 while the silicon nitride waveguide 930 is patterned on silicon oxide 912. The surface-to-surface gap between the upper silicon nitride waveguide 930 and the lower silicon nitride input waveguide 910 and the lower silicon nitride output waveguide 920 can be varied to adjust the maximum vertical coupling efficiency. The layers 911, 912 and 913 forms the top, buffer and bottom layers of the waveguide 901 which are formed on the silicon substrate 935.

FIG. 10 shows the simulated results 1011 for the vertical power coupled from the lower silicon nitride straight waveguide 910 to the upper silicon nitride straight waveguide 930 in the coupling regions 970 and 980 of FIG. 9. As can be seen from this figure that for the silicon nitride waveguide width of 2.8 um and thickness 100 nm when the surface-to-surface gap between the two vertical waveguides is 1.95 um and coupling length is 150 μm, the power remains in the input silicon nitride waveguide 910 is 0.0064 or power coupled to the output vertical waveguide 930 is 0.9944 or 99.34%. Similarly, the vertical power coupled from the upper silicon nitride waveguide 930 to the lower silicon nitride waveguide 920 in the coupling region 980 of the same FIG. 5 is 99.34%. The refractive index of the silicon nitride is chosen to be 2.08 for this simulation.

FIG. 11 shows the plot 1111 of minimum rotation (deg/h/sqrt (Hz)) vs spiral length (meter) for two types of noises i.e., short noise and thermal noise when the propagation loss of the spiral loop is 0.5 dB/km at wavelength of 1550 nm. Both the noises have the optimum values when plotted as the spiral length. For the source input power of 100 mW and the spiral loop length of 22.2721 meter, the number of loops required to fit in 2 cm×2 cm reticle are about 526 with the same silicon nitride waveguide of 28 um width and 100 nm thickness and surface to surface spiral waveguide spacing of 10 μm. The corresponding minimum rotations for shot noise and thermal noise are 0.28 (deg/h/sqrt (Hz)) and 0.5 (deg/h/sqrt (Hz)) with the total noise (sum of shot noise and thermal noise) is being 0.78 (deg/h/sqrt (Hz)).

However as shown in FIG. 12 through the plot 1211 when the propagation loss of the spiral loop is increased to 3 dB/km at wavelength of 1550 nm, the spiral loop length decreases to 5.38875 meter with the corresponding smaller number of loops 90 for the same source input power of 100 mW while silicon nitride surface to surface spiral waveguide spacing remains 10 μm. In this case, the corresponding minimum rotations for shot noise and thermal noise increased to 1.57 (deg/h/sqrt (Hz)) and 1.59 (deg/h/sqrt (Hz)), respectively with the increase in total noise (sum of shot noise and thermal noise) to 3.16 (deg/h/sqrt (Hz)).

For low loss silicon nitride waveguides when the propagation loss is of the order of 0.5 dB/meter at wavelength of 1550 nm, the simulations show that to get the total detector noise (sum of shot noise and thermal noise) rotation rate 0.78 (deg/h/sqrt (Hz)), the spiral length about 22 meter is needed that can be fitted in a reticle of the size 2 cm×2 cm with the silicon nitride waveguide of 2.8 um width and 100 nm thickness and surface to surface waveguide spacing of 10 um. However, for the propagation loss of 0.1 dB/meter at wavelength of 1550 nm, the spiral loop length becomes much larger than 22.2721 meter and cannot be fitted into one reticle and therefore multiple reticles are needed. The geometry shown in FIG. 8 is a method for achieving longer spirals when warranted by low-loss waveguides.

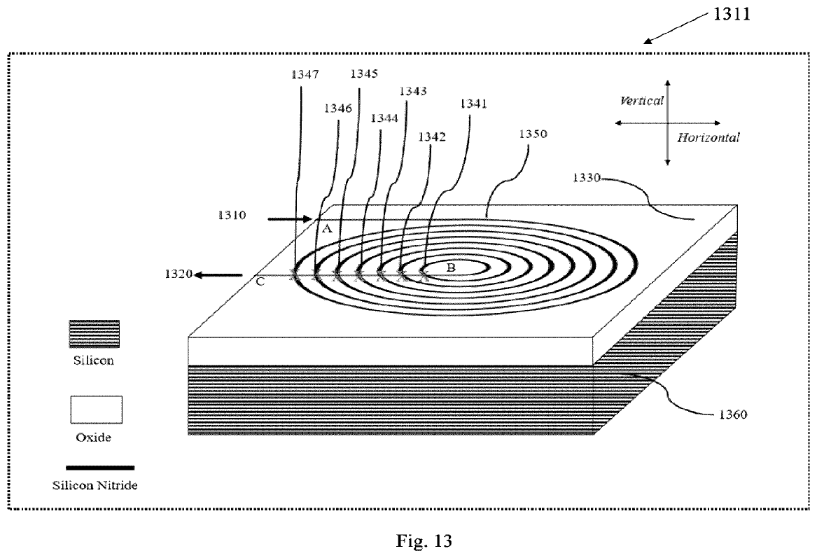

FIG. 13 is the perspective schematic view 1311 of a spiral loop with waveguide crossings. The spiral loop 1350 with waveguide crossings can be replaced by a single spiral loop in FIGS. 1 and 3. The spiral loop 1350 in FIG. 13 does not require the vertical coupling from silicon nitride waveguide in the second layer as shown in FIGS. 1, 3 and 5, thereby simplifying manufacture. However, the spiral loop 1350 adds to the losses at each crossing and that two times, one for the input beam propagating from A to B and other for the output beam propagating from B to C. Referring to the same FIG. 13, the light from laser source enters the silicon nitride loop 1350 via silicon nitride input waveguide 1310 and exit through silicon nitride output waveguide 1320. While propagating from A to B, the input beam will propagate through the crossings 1347, 1346, 1345, 1344, 1343, 1342 and 1341 and while propagating from B to C, the output beam will propagate through the crossings 1341, 1342, 1343, 1344, 1345, 1346 and 1347. The input waveguide 1310, output waveguide 1320 and loop 1350 are patterned on thermally grown silicon oxide 1330 on silicon wafer 1360. The phase modulators of FIGS. 5, 17 and 18 can be placed just after input waveguide 1310 or just before the output waveguide 1320.

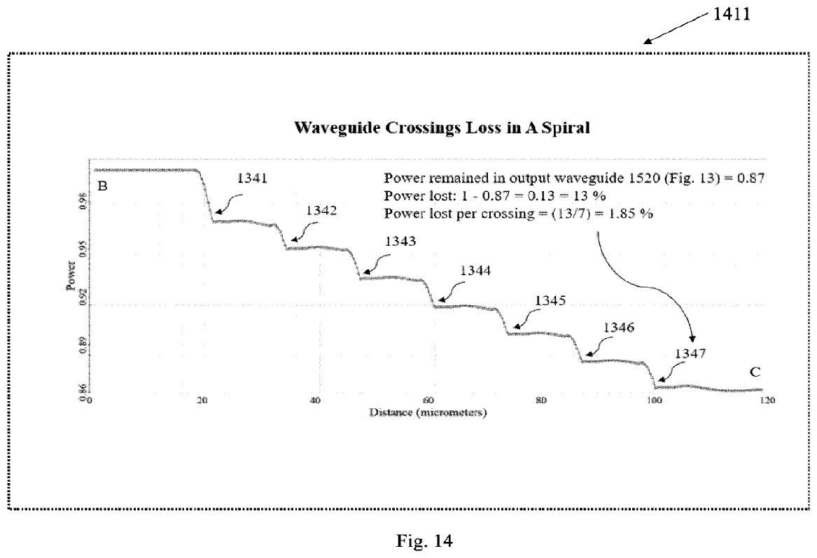

FIG. 14 shows the simulated losses 1411 for an output light beam while propagating from B to C. In this case the light beam will propagate through 7 waveguide crossings labeled as 1341, 1342, 1343, 1344, 1345, 1346 and 1347 similar to the waveguide crossings of FIG. 13. Referring to the FIGS. 13 and 14, the power remained in the output waveguide 1320 is about 0.87 or 87% that means about 13% power is lost while propagating through 7 crossings or 1.85% (0.06 dB) while propagating through each crossing. In the simulations the silicon nitride waveguide thickness is considered to be 100 nm while the width remains to be 2.8 um for supporting the fundamental TE mode only while higher order TE modes are absent. The estimated waveguide crossings loss for 90 loops while propagating from A to B and then B to C of FIG. 13 is estimated to be 10.8 dB (0.06 dB×2×90). In all cases, the crossings have to be perpendicular to the spiral loops as any deviation from this will result in additional coupling between the crossing waveguides.

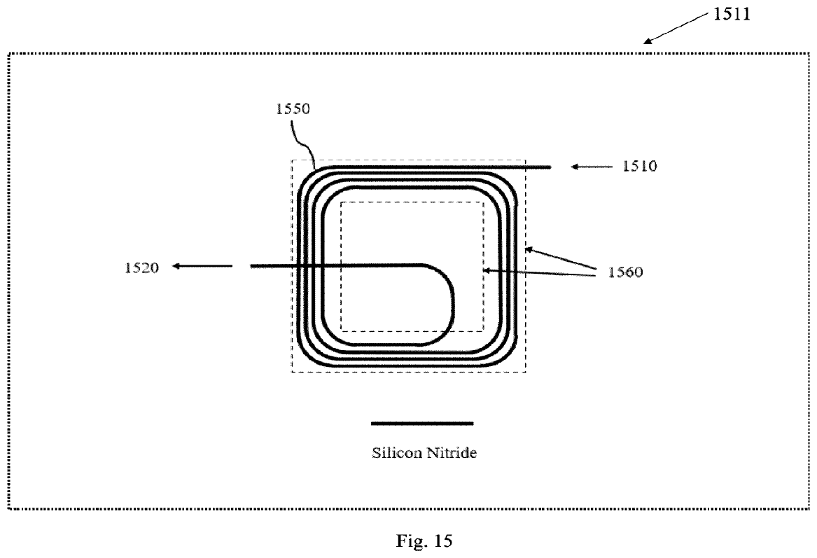

FIG. 15 is the perspective schematic view 1511 of a spiral loop 1550 where silicon underneath the region (area) enclosed between the broken lines 1560 will be selectively etched away. This spiral loop can be replaced by a single spiral loop such as those in FIG. 1 or 3. Referring to FIG. 15, light enters the silicon nitride spiral loop 1550 through silicon nitride input waveguide 1510 and then exits the silicon nitride output waveguide 1520. The spiral loop 1550 can be replaced by spiral loop 1350 in FIG. 13 or in FIGS. 1 and 3. The phase modulators of FIGS. 5, 17 and 18 can be placed just after input waveguide 1510 or just before the output waveguide 1520. As shown in FIG. 15, the silicon underneath the region (area) enclosed between the broken lines 1560 will be etched with XeF2 (Xenon Difluoride) to form a plurality of air cavities therein. See again, for reference, U.S. patent application Ser. No. 18/110,989.

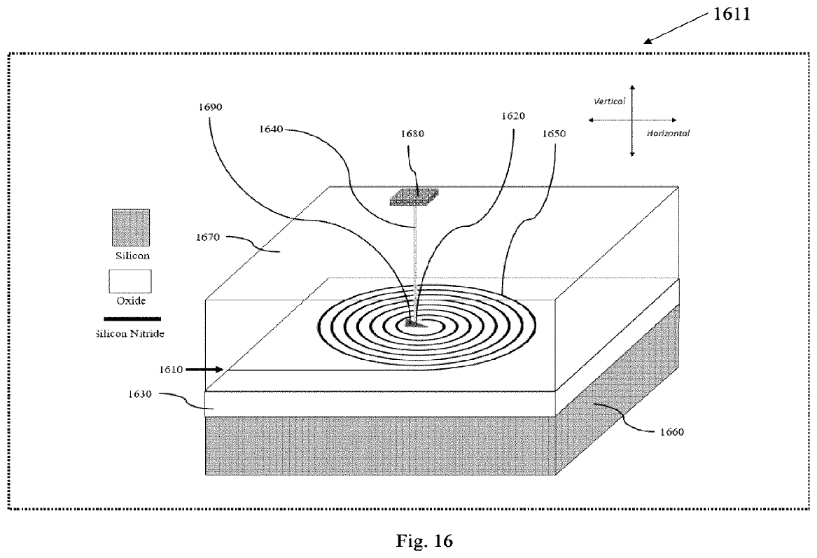

FIG. 16 is the perspective schematic view 1611 of a spiral loop 1650 where at the central of spiral loop 1620 a reflecting mirror 1690 is constructed that reflects the beam in vertical direction 1640 to the detector 1680. The spiral loop 1650 can be replaced by a single spiral loop in FIG. 1. Referring to FIG. 16, light enters the silicon nitride spiral loop 1650 through silicon nitride input waveguide 1610 and then exits the silicon nitride output waveguide 1620 and is vertically reflected by a mirror 1690 to be detected by a germanium detector 1680 bounded on the top silicon oxide 1670. The input waveguide 1610, output waveguide 1620, and the loop 1650 are patterned on thermally grown silicon oxide 1630 on silicon wafer 1660. The mirror 1690 can be formed by crystallographic etching of silicon or added to a trench etched in silicon dioxide such that the reflecting angle with respect to input and output beam is between 45 and 54.7 degrees. The phase modulator in FIG. 5 can be placed just after the input waveguide 1610.

FIG. 17 is the perspective cross sectional view 1711 of SiN/PZT phase modulator with PZT material 1720. The PZT material 1720 is vertically sandwiched between the two metal electrodes 1710 and 1711 for electrical actuation. The single stripe silicon nitride waveguide 1730 is patterned on the thermally grown bottom silicon oxide 1732 which in turn formed on the silicon substrate 1735. The layer 1731 is the top oxide layer which separates the silicon nitride waveguide 1730 from the bottom electrode 1711 in such a way that the evanescent field of the fundamental TE mode is not get attenuated due to the bottom metal electrode 1711. This SiN/PZT phase modulator 1711 can be replaced by lithium niobate phase modulator of FIG. 5.

FIG. 18 is the perspective cross sectional view 1811 of PZT phase modulator with U-shaped PZT material 1820 and is also shown by the top view 1890. The U-shaped PZT material 1820 is vertically sandwiched between the two metal electrodes 1810 and 1811. The single stripe silicon nitride waveguide 1830 is patterned on the thermally grown bottom silicon oxide 1832 which in turn formed on the silicon substrate 1835. The layer 1831 is the top oxide layer which separates the silicon nitride waveguide 1830 from the bottom electrode 1811 in such a way that the evanescent field of the fundamental TE mode is not get attenuated due to the bottom metal electrode 1811. This PZT phase modulator can be replaced by lithium niobate phase modulator of FIG. 5 or the PZT modulator illustrated in FIG. 17.

Modifications and improvements to the above-described embodiments of the present technology may become apparent to those skilled in the art. The foregoing description is intended to be exemplary rather than limiting.

1. An integrated photonic gyroscope comprising:
a light source;
a wavelength filter optically connected to the light source;
at least one interferometric spiral loop optically connected to a wavelength filter, the at least one interferometric spiral loop being formed from silicon nitride; and
a detector optically connected to the interferometric spiral loop for receiving light therefrom.

2. The integrated photonic gyroscope of claim 1, wherein the wavelength filter comprises at least one ring resonator filter formed from silicon nitride.

3. The integrated photonic gyroscope of claim 1, further comprising:
a phase modulator optically connected between the at least one interferometric spiral loop and the detector.

4. The integrated photonic gyroscope of claim 1, further comprising:
a phase modulator optically connected between the wavelength filter and the at least one interferometric spiral loop.

5. The integrated photonic gyroscope of claim 4, further comprising:
a substrate; and
wherein:
the at least one wavelength filter is formed in a first material layer disposed on the substrate, and
the phase modulator is formed in a second material layer disposed parallel to the first layer.

6. The integrated photonic gyroscope of claim 4, further comprising:
a substrate; and
wherein:
the at least one wavelength filter and the phase modulator are formed in a material layer connected to the substrate.

7. The integrated photonic gyroscope of claim 3, wherein:
the phase modulator is at least one thin film lithium niobate waveguide (TFLN) phase modulator; and
the at least one TFLN phase modulator includes:
at least one lithium niobate waveguide, and
a plurality of metal electrodes disposed adjacent to the at least one lithium niobate waveguide.

8. The integrated photonic gyroscope of claim 3, wherein:
the phase modulator is at least one SiN/PZT phase modulator; and
the at least one SiN/PZT phase modulator includes:
a silicon nitride waveguide, and
electrodes including lead zirconate titanate (PZT), the electrodes being horizontally displaced from the waveguide.

9. The integrated photonic gyroscope of claim 1, further comprising at least one photonic wire bond connecting a waveguide to the detector.

10. The integrated photonic gyroscope of claim 1, further comprising:
a waveguide formed from thin film lithium niobate (TFLN), and
a Germanium or silicon detector added to silicon substrate.

11. The integrated photonic gyroscope of claim 1, further comprising:
a plurality of horizontally straight and tapered evanescent field vertical couplers and
wherein evanescent coupling occurs between vertically placed dissimilar silicon nitride and silicon waveguides.

12. The integrated photonic gyroscope of claim 11, further comprising:
a vertical coupling region comprising:
a silicon nitride straight waveguide after tapering having an about 0.5 um width and an about 100 nm thickness;
a silicon waveguide having an about 500 nm width and about 220 nm thickness; and
a vertical separation between silicon nitride straight waveguide and a silicon waveguide of:
about 1.95 um for 10% coupling,
0.88 um for 50% coupling, and
0.18 um for 97% coupling.

13. The integrated photonic gyroscope of claim 1, further comprising:
a plurality of horizontally straight and tapered evanescent field vertical couplers; and
wherein evanescent coupling occurs between vertically placed dissimilar silicon nitride and lithium niobate waveguides.

14. The integrated photonic gyroscope of claim 13, further comprising:
a vertical coupling region comprising:
a silicon nitride straight waveguide having an about 2.8 um width and an about 100 nm thickness;
a lithium niobate waveguide having an about 1.5 um width and an about 100 nm thickness; and
a vertical separation between the silicon nitride straight waveguide and the lithium niobate waveguide by about 0.825 um for 99.97% coupling.

15. The integrated photonic gyroscope of claim 1, further comprising:
a reflecting mirror formed from silicon, the reflecting mirror providing optical coupling between the at least one interferometric spiral loop and the at least one detector.

16. The integrated photonic gyroscope of claim 1, further comprising:
at least one vertical coupler; and
a plurality of etched cavities defined in material below the at least one interferometric spiral loop,
none of the plurality of etched cavities being defined in regions immediately below a coupling region defined around the at least one vertical coupler.

17. The integrated photonic gyroscope of claim 1, wherein the light source comprises at least one of:
a super luminescent diode (SLD) source; and
an amplified spontaneous emission (ASE) source.

18. The integrated photonic gyroscope of claim 1, wherein the light source comprises a semiconductor optical amplifier (SOA).

19. An integrated photonic gyroscope comprising:
a semiconductor optical amplifier (SOA);
at least one interferometric spiral loop optically connected to a wavelength filter, the at least one interferometric spiral loop being formed from silicon nitride; and
a detector optically connected to the interferometric spiral loop for receiving light therefrom.
